(19) United States
(12) Patent Application Publication
(10) Pub. No.: US 2003/0194302 A1
(43) Pub. Date: Oct. 16, 2003

(54) Materials handling apparatus and method

(76) Inventor: Andrew James Hickinbotham, Dromana (AU)

Correspondence Address: LOWE HAUPTMAN GILMAN & BERNER, LLP, Suite 310, 1700 Diagonal Road, Alexandria, VA, 22314, US

(21) Appl. No.: 10/121,544

(22) Filed: Apr. 15, 2002

(51) Int. Cl. A01J 15/14

(52) U.S. Cl. 414/432; 99/277; 99/467

(57) ABSTRACT

A container apparatus and method for handling fruit must (M). The apparatus (1) includes a rigid support structure (2) and, a flexible container (7) for holding a quantity of fruit must (M). The holding container (7) supported by the support structure (2) when holding the must (M). The holding container (7) has at least one opening (12) through which at least juice of the must (M), or wine, is removed. During fruit must (M) the holding container (7) is positioned in the support structure (2) and a quantity of fruit must (M) poured into the container (7). At least juice of the must (M), or wine, is removed through the opening (12). A flexible bag container (7) for use in the apparatus and method is also disclosed.

### FIELD OF THE INVENTION

This invention relates generally to an apparatus and method for materials handling and, in particular, container apparatus for handling flowable material as well as a method for handling that material using the container apparatus.

The apparatus and method are applicable for handling crushed fruit such as grapes and/or its juice during processing, including fermentation into wine and pre- and post-fermentation maceration, and it will be convenient to hereinafter disclose the invention in relation to that exemplary application. In so describing the invention, the term “crushed” should be understood as referring to the fruit which has been crushed and which includes the fruit juice, pulp, and skins, and may also include the seeds and stems. As will be appreciated by those skilled in this art, the juice before fermentation, either alone or together with the pulp, skins, seeds and/or stems, may be known as “must”, and that term will be used accordingly hereinafter.

### BACKGROUND OF THE INVENTION

Handling of crushed grapes and must, including fermentation into wine, is currently conducted using reusable stainless steel tanks, concrete vats and other rigid, permanent containers. The stainless steel tanks, purpose designed and constructed and capable of holding grape material, are very expensive. Such containers are only cost effective with high volumes of grape material, where they can be repeatedly cleaned and recharged with must batches during a grape processing season. Accordingly, such tanks are not cost effective propositions for small to medium wine makers. Even with large volume wine makers, a coordinated regular supply of grapes through an extended season is necessary to ensure efficient use of the tanks, and that can be difficult to achieve with unpredictable weather patterns and fermentation rates.

Season-to-season fluctuations in the volume of grapes to be processed compound difficulties of individual wine makers in determining the optimum equipment requirements to achieve that processing. The specialist nature of, and attendant capital investment in, the equipment involved means that wine makers want to try and avoid excess processing capacity. However, a shortage of equipment, even for one season, may result in substantial wine grape spoilage and so loss of production income These difficulties particularly extend to the currently adopted container arrangements where rigid containers provide wine makers with fixed grape handling and fermenting capacities, and thus little scope for effectively accommodating fluctuating grape volumes.

An additional problem with these container arrangements is that their cleaning and recharging is time consuming and costly. That is more so given that it necessitates down time in the use of the containers during their most productive period.

### SUMMARY OF THE INVENTION

An object of the present invention is to provide an alternative container apparatus which is both relatively simple and inexpensive. As a consequence, the apparatus is particularly suited for handling seasonally fluctuating volumes of flowable material such as crushed grapes and other fruit during wine production.

Another object of the present invention is to provide container apparatus which requires reduced cleaning, or can be readily disposed of, following use.

A further object of the present invention is the provision of container apparatus which has reduced storage requirements when not in use.

Another object of the present invention is the provision of a simple and inexpensive method for handling flowable material such as crushed grapes and other fruit during wine production.

An additional object of the present invention is the provision of a bag container suitable for use in the container apparatus and method.

In one aspect, the present invention provides a container apparatus for handling fruit must, including a holding container composed of flexible sheet material for holding a quantity of fruit must, the holding container having at least one opening for removing at least juice of the must or wine, therefrom.

In a further aspect, the present invention provides a container apparatus for handling fruit must, including: a rigid support structure; and, a flexible container for holding a quantity of fruit must, the holding container being supported by the support structure when holding the must, and the holding container having at least one opening through which at least juice of the must, or wine, is removed therefrom.

In another aspect, the present invention provides a flexible bag container for handling fruit must, the container including: a holding compartment for holding a quantity of fruit must; at least one opening from the holding compartment through which must is removed therefrom; a control compartment adjacent the holding compartment; and, at least one opening into the control compartment for introducing a pressing fluid so as to expand the control compartment and apply a force to the adjacent holding compartment causing at least juice of the must, or wine, to flow out through the or at least one opening from the holding compartment,

In a still further aspect, the present invention provides a flexible bag container for handling fruit must, the container including: a holding compartment for holding a quantity of fruit must; at least one opening from the holding compartment through which must is removed therefrom; a control compartment adjacent the holding compartment; and, at least one opening into the control compartment for introducing a heat exchange fluid so as to cause convected transfer of heat between the heat exchange fluid and the must in the holding compartment.

In another aspect, the present invention provides a flexible bag container for grape must fermentation, the container including: an inner bag for holding a quantity of grape must during fermentation; at least one opening from the inner bag through which ferment is removed therefrom; an outer bag containing the inner bag, the inner and outer bags being composed of sheet material having predetermined gas permeability characteristics for controlling gas flow between the grape must and the container exterior.

In yet another aspect, the present invention provides a method for handling fruit must, including: positioning a flexible holding container in a rigid support structure; pouring a quantity of fruit must into the holding container, the holding container being supported by the support structure; and, removing at least juice of the must, or wine, through an opening from the holding container.

Preferably, the apparatus also includes control means for applying a force to the must causing the must juice or wine to flow out through the or at least one opening in the holding container. That control means force preferably causes the must to be pressed and juice to be separated from fruit pulp and skins of the must,

Preferably, the control means includes a control member. That member is inflatable to apply the force and press against the must. The control member includes an inflatable control container having a control compartment expandable under pressure of fluid introduced into the control compartment so as to inflate the control container, in one preferred form.

In one preferred arrangement, the control container is located between the holding container and the rigid support structure. The rigid support structure restrains the control container and controls the direction of inflation of the control container toward the holding container so as to apply a force to the holding container.

In one form, the control container is located beneath the holding container. In this form, inflation of the control container causes the bottom of the holding container to progressively rise so as to press the must juice between the rising container bottom and a top of the holding container. The control container preferably at least partially-surrounds the holding container in this form so that inflation of the control container causes the holding container to deflate and apply a force to the must. The control container may extend over the top and about the side(s) of the holding container, in this form.

In another preferred arrangement, the holding container is located between the control container and the rigid support structure. With this arrangement, the rigid support structure restrains the holding container as the control container inflates so as to apply a force to the must.

In one form the holding container at least partially surrounds the control container. In this form inflation of the control container causes the must to progressively compress outwardly against the rigid support structure. The control container may be located within the holding container.

The control compartment may be pneumatically or hydraulically expanded with fluid supplied from a suitable pressurised source through a pipe or hose to an opening into the control compartment. In one form, the fluid is water and in another form the fluid is air. The opening is located adjacent the bottom of the control compartment where the control member is located adjacent the base of the support structure, and is located toward a side or the top of the control member where the control member is located on top of the container and/or adjacent walls of the support structure.

In a preferred form and in the exemplary application of the invention, expansion of the control compartment occurs over an extended period of time, for example several hours. Moreover, in this form the compartment is expanded with relatively low pressure fluid, for example fluid at or below about 8 Kpa.

Preferably, the holding container is a holding bag and the control container is a flexible control bag. The control bag may be formed integral with, or separate from, the holding bag.

In at least one preferred form, the holding bag is composed at least in part of stretchable, flexible sheet material. The control bag may also be composed at least in part of that same material. This form is particularly suitable for the arrangement in which the juice is fermented in the container, since it enables at least part of the bag(s) to stretch expand or inflate under internal pressure produced by fermentation. In this form, the support structure will not so completely support or restrain the bag(s) as to prevent some expansion or inflation thereof. In a preferred form, the bag(s) will be free to expand at least in its upper region, so that the upper region will distend to a dome shape under pressure of the ferment

In a preferred form, the sheet material is inert to the material held therein so as to not adversely affect the qualities thereof. Moreover, in the exemplary application the material is impermeable to liquid so as to retain the fruit juice therein. The material may also be gas impermeable, although some gas permeability is acceptable such as to permit micro oxygenation of the ferment and to assist in escape of the ferment gas.

The holding bag sheet material may be a laminate of two or more sheets in order to provide the above and other acceptable characteristics for the container, having regard to its intended application. Those other characteristics may include being durable and strong. One or more sheets may be composed of plastics such as nylon, and one or more other sheets may be composed of metal such as aluminium. The sheet material will be typically of food grade quality, at least where it comes into contact with the must in the exemplary application of the apparatus.

In one preferred form, the holding container defines a compartment for holding the fruit must and with which the opening communicates. The opening is located at or adjacent the top of the container, in a preferred form. That opening is located centrally within a top wall of the holding bag container, in one form.

The upper opening is relatively small compared with the size and holding capacity of the container. The must preferably flows in a pipe through this opening into the holding compartment and the juice or wine flows out through the opening, in one form. The container may have a connection facility at the opening to enable a pipe to be connected to the container at that opening so as to facilitate fluid flow into and out of the compartment without spillage.

Preferably, the apparatus further includes means for controlling the temperature of the fruit must in the holding container. That temperature control means preferably includes a passageway adjacent the holding container, passage of heat exchange fluid through the passageway causing convected transfer of heat between the heat exchange fluid and the must in the holding container. In one preferred form, the passageway is provided by the control compartment In this form, the control container has at least two openings into the control compartment to enable flow of heat exchange fluid into and out of the openings, respectively.

In at least one preferred form, the support structure for the holding container provides at least side support so as to prevent the container from laterally shifting upon any movement of the compartment contents. To that end, in one form the support structure includes one or more upright support walls against which the container holding fruit must rests for support. Four walls arranged in a quadrangular box-like configuration and defining a storage space for receiving the container are provided, in one form.

In one form, the support structure also provides bottom support for the container bearing thereon. Accordingly, in this form the support structure also includes a support base. The support walls upstand from that base, in this form.

In one preferred form, the support structure is a support crate. In this form, the crate is open topped, and the four support walls are connected to the base so as to provide a unitary construction. The crate may be collapsible when not in use so as to reduce the storage space required. The base of the crate may be of a pallet construction to enable handling by forklift trucks and other handling equipment. The crate is preferably of a size so that the container is at least substantially, if not completely, contained therein when full of fruit must.

In the arrangement in which the fruit must is fermented in the holding container, the upper opening is left open to permit ferment gas to escape. In order to direct the gas away from the opening, the apparatus can further include a gas discharge tube for extending externally away from the container opening. The tube is removably connected to the connection facility at the container opening, in one form.

As will be well known to those skilled in this art, within the must the skins tend to rise and float on top of the juice. During fermentation this separation is stimulated and increased under action of the ferment gas. The gas forces the skins to the top where they may form into a relatively solid cap. This cap constricts ferment gas flow from the underlying fermenting juice, thereby increasing gas pressure within the container. As a result, the cap is forced against the top wall of the container causing it to distend whilst all other dimensions of the container are maintained by the support walls.

In order to relieve excessive gas pressure build up beneath the cap, the container apparatus, in one preferred form, includes a fermentation tube. That tube extends within the gas discharge tube into the container to a level beneath that at which the cap forms. Thus, in use, the ferment tube protrudes through the cap into the fermenting grape juice thereby providing communication for the ferment gas through the cap into the gas discharge tube.

In one form, the fermentation tube extends from a lower end opening below the level at which the cap forms, through the container opening, to an upper end opening in the gas discharge tube. The fermentation tube has a smaller cross-sectional dimension than the gas discharge tube so that a passage is defined between them. With this arrangement, in use, pressure build up in the container forces fermenting juice and the ferment gas up through the fermentation tube. As the juice and gas flow from the open upper end of the fermentation tube into the discharge tube, the juice returns through the passage, under influence of gravity, to the container, whilst the ferment gas escapes through the discharge tube to the atmosphere. The fermenting juice flowing onto the skins helps irrigate them and extract colour into the juice.

In a preferred form of the present invention, the fruit must is pumped or otherwise poured into the holding compartment. When the must is supplied through a hose or pipe, then that hose or pipe may be connected or coupled to the connection facility at the opening, although that is not necessary. In this form, the holding container is positioned in the support crate prior to must supply. The container is typically completely filled with the must,

### BRIEF DESCRIPTION OF THE DRAWINGS

It will be convenient to hereinafter describe the invention in greater detail by reference to the accompanying drawings which illustrate two embodiments of the invention applied to a container apparatus and method for handling crushed grapes or grape must. The particularity of the drawings and the related description is not to be understood as superseding the generality of the preceding broad description of the invention.

In the drawings (where the same reference numerals identify the same components or features):

FIG. 1 is a cross-sectional side view of handling apparatus according to one embodiment of the present invention;

FIG. 2 is a side view similar to FIG. 1 but with the apparatus containing a quantity of crushed grapes or grape must,

FIG. 3 is a side view similar to FIG. 2 but with the grapes or must undergoing fermentation;

FIG. 4 is a side view similar to FIG. 3 but following commencement of removal of wine therefrom;

FIG. 5 is a side view similar to FIG. 4 following removal of the wine therefrom;

FIG. 6 is a cross-sectional view similar to FIG. 2 of handling apparatus according to another embodiment of the present invention; and

FIG. 7 is a cross-sectional view similar to FIGS. 3 and 6 of handling apparatus according to a further embodiment of the present invention.

### DETAILED DESCRIPTION OF THE PREFERRED EMBODIMENTS

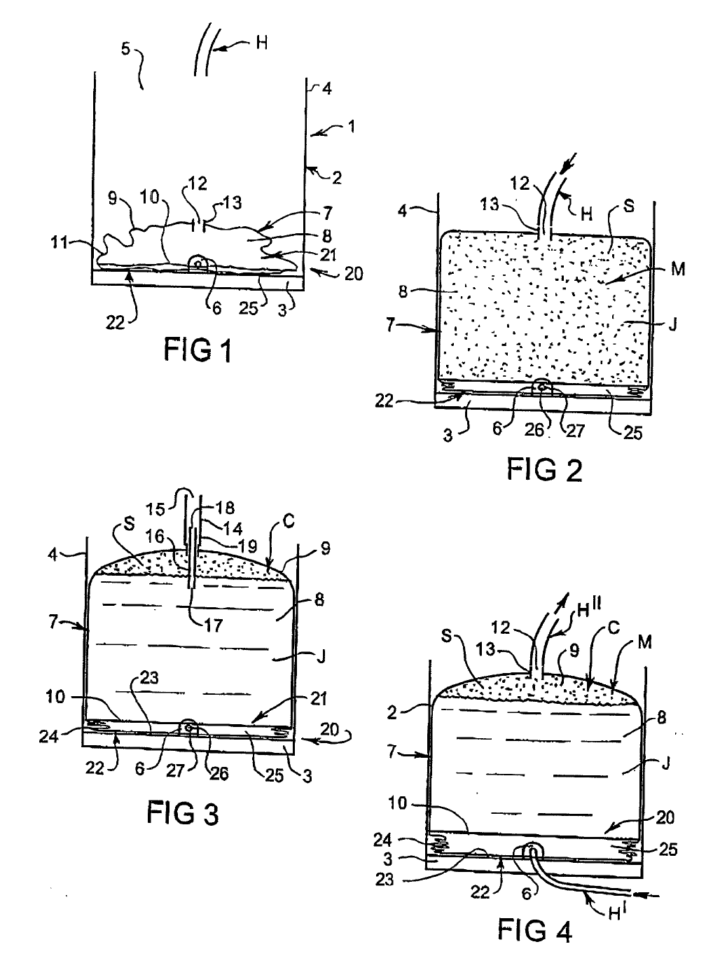

Referring to FIGS. 1 to 5 of the drawings, there is generally shown a container apparatus 1 for handling crushed grapes or grape must M. The grapes or must M contain at least grape juice J and skins S which, as shown in FIG. 3 and as will be explained in more detail hereinafter, tends to form a cap C during fermentation.

The apparatus 1 includes a support crate 2 having a pallet-like base 3 and supporting side walls 4 extending upwardly therefrom so as to define an open topped storage space 5. The walls 4 may be dismountable from the base 3 for flat stacking thereon in order to reduce volume storage and transportation of the crate 2 when not in use.

One of the side walls 4 has an access opening 6 adjacent the base 3 for access into the storage space 5. The purpose of this opening 6 will become more apparent hereinafter.

The apparatus 1 also includes a bag like holding container 7 removably placable within the storage space 5. The container 7 has a holding compartment 8 for holding a quantity of crushed grapes or must M. In the exemplary application, the holding compartment 8 has a capacity of about 800 litres, although it will be appreciated that other compartment volumes may be selected for particular applications. The compartment 8 is defined by a top wall 9, bottom wall 10 and one or more side walls 11 extending therebetween.

The container 7 is composed of flexible plastic and/or metal laminate sheet material. Where the apparatus 1 is used for fermenting juice J then at least the top wall 9 will be composed of stretchable material allowing it to distend into a dome shape under pressure generated during the fermentation process. In the exemplary application, the container 7 will typically have a single use life, ie the handling of one batch quantity of grapes or must M prior to disposal.

An opening 12 is provided in the top wall 9 for supply of grapes or must M into the holding compartment 8 and removal of grape juice J or wine therefrom. The container 7 is closed from liquid flow into and out of the holding compartment 8 except through opening 12 The opening 12 is defined by a pipe or hose coupling 13 fitted into the top wall 9 and to which a pipe or hose H can be connected for flow of grapes or must M, and juice J or wine therethrough. The coupling 13 may be seam welded or otherwise sealed into the top wail 9, and provide any suitable sealed connection to the pipe or hose H.

The apparatus 1 further includes a gas discharge tube 14 releasably connectable to the coupling 13. That discharge tube 14 extends externally of the container 7 to an open end 15 communicating with the surrounding atmosphere.

In addition, a ferment tube 16 is fitted within the discharge tube 14. That tube 16 extends from an open lower end 17 within holding compartment 8 to an open upper end 18 within the discharge tube 14 below the open end 15 thereof. The ferment tube 16 is of a smaller cross sectional size than the discharge tube 14 so as to define flow passage 19 therebetween.

The apparatus 1 further includes control means 20 operable to apply an external force to the container 7 so as to cause it to be compressed or collapse. The control means 20 includes a control member 21 which, in this embodiment, is constructed integral with the container 7. It should be appreciated, however, that in alternative embodiments (not shown), the control means 20 may be quite separate from the container 7.

The control member 21 includes a bag-like control container 22 arranged beneath the container 7 between the bottom wall 10 thereof and the crate base 3, The control container 22 is composed of the same material as the holding container 7, and has a bottom wall 23 and at least one side wall 24 which, together with the bottom wall 10 of the holding container 7, defines a expandable control compartment 25. Bottom wall 10 forms a dividing wall between the holding compartment 8 and control compartment 25.

An opening 26 is provided in the side wall 24 adjacent the bottom wall 23 for supplying low pressure fluid, such as water, into the compartment 25 for expansion thereof. Opening 26 is defined by a pipe or hose coupling 27 which may be similar to coupling 13, fitted into the side wall 24 and to which a pipe or hose H′ can be connected for flow of pressurised fluid into the compartment 25. The coupling 27 is aligned with the access opening 6 in the crate side wall 4 to enable easy access by the pipe or hose H′.

In use of the apparatus 1 in the exemplary application, the integral containers 7 and 22 are placed in the storage space 5 of crate 2, with the coupling 27 aligned with access opening 6. The respective holding compartment 8 and control compartment 25 are initially collapsed as shown in FIG. 1. Hose H is connected to coupling 13 and grapes or must M pumped into the holding compartment 8 so as to completely fill the compartment 8 as shown in FIG. 2. The hose H is then disconnected from the coupling 13.

In one arrangement, the apparatus may be simply used to separate the grape juice J out of the crushed grapes or must M. In that application, when it is desired to remove the juice J from the compartment 8, compartment 25 is connected to a source of low pressure water through hose H′ connected to coupling 27. As water is supplied into the compartment 25 it progressively expands, inflating the container 22 and applying a force to the bottom wall 10 of the container 7. As a result the bottom wall 10 tends to rise toward the top wall 9 as shown in FIG. 4.

Frictional contact between the crate side walls 4 and container side walls 11 may be sufficient to restrain the entire container 7 within storage space 5 against riding upwardly on the expanding control container 22. However, an auxiliary restraint, such as tie down straps (not shown) may be provided so as to restrain container 7 against that upward movement.

Continued expansion of the control compartment 25 causes the juice J to commence flowing out of the holding compartment 8 through the opening 12. Another hose H″ may be connected to coupling 13 as shown in that FIG. 4 to enable the juice J to be taken away for further processing. The skins S within the crushed grapes or must M will tend to float upwardly within the grapes or must M and accumulate against the top wall 9. The restricted size of the opening 12, and relatively slow expansion of the control compartment 25 minimises entrainment of those skins S in the juice J being removed from the compartment 8.

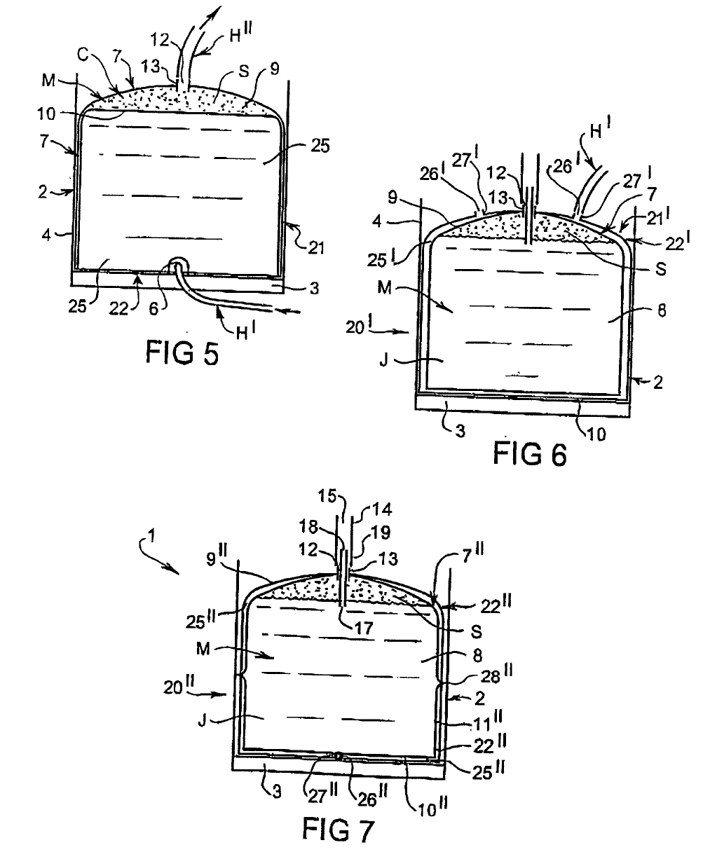

Expansion of the control compartment 25 continues until the compartment 25 is fully expanded and all of the free running juice J is removed from the compartment 8 as shown in FIG. 5. In addition, the fruit pulp and skins S may undergo some pressing during the final expansion of the compartment 25, releasing further juice J from the grapes or must M.

The control compartment 25 is then emptied through reverse flow of the low pressure water through hose H′. The integral containers 7 and 22 can then be removed from the crate 2 and container 7 slashed open to access the retained skins S. Those skins S may undergo a secondary pressing in separate equipment for removal of any residual juice J and eventually composted or discarded.

In using the apparatus 1 to ferment the grape juice J into wine, after pumping the grapes or must M into the holding compartment 8, the gas discharge tube 14 is connected to the coupling 13. The must M is then inoculated with a fermentation yeast.

As fermentation commences, the skins S are forced toward the top wall 9 under influence of ferment gas produced during the fermentation. That gas rises through the grapes or must M and escapes via the discharge tube 14.

As the fermentation becomes more active, the skins S become compacted against the top wall 9 restricting escape of the ferment gas. Progressively increasing pressure within the compartment 8 causes the top wall 9 to distend to a dome shape as shown in FIG. 3 To alleviate excess pressure build up the ferment tube 16 is fitted into the discharge tube 14. That ferment tube 16 extends through the skin cap C into the fermenting juice J. The fermenting juice J and ferment gas flow up the ferment tube 16 to its open upper end 18 where the gas is released into the discharge tube 14 whilst the juice return flows through passage 19 into the holding compartment 8, irrigating the cap C in the process.

This circulation of the fermenting juice J continues until the end of fermentation. At that stage the skins S slowly sink through the fermented juice (wine) to settle on the bottom wall 10.

Upon completion of the fermentation process the wine is removed from the holding compartment 8. That can be achieved by disconnecting the tubes 14 and 16 from the coupling 13, and operating the control means 20 as described above.

FIG. 6 of the drawings shows a similar container apparatus 1 to that of FIGS. 1 to 5, but with a modified control means 20′. FIG. 6 shows the same stage of use of the apparatus as shown in FIG. 3 of the previous embodiment. It will be appreciated that the apparatus of this embodiment will proceed through each of the stages of the earlier embodiment during apparatus use.

In this embodiment, control means 20′ includes an outer bag like control container 22′ defining control compartment 25′ in which inner bag like holding container 7 is positioned. Coupling 13 in the top wall 9 of the container 7 also extends through the top wall of container 22′ to provide access opening 12 for flow of grapes or must M and juice J or wine therethrough. Container 22′ may be seam welded or otherwise sealed to the coupling 13 to maintain the integrity of the compartment 25′.

At least one opening 26′ is provided in the container 22′ toward the top thereof for supplying low pressure fluid into the compartment 25′. That fluid pressure acts to compress or deflate the holding container 7 within the compartment 25′ to cause juice or wine to be removed from the compartment 8 as described above in relation to the previous embodiment. Opening 26′ is defined by a pipe or hose coupling 27′ for connection of a pipe or hose H′ supplying the low pressure fluid into the compartment 25′.

Only one opening 26′ is required for pressurising the compartment 25′. However, as shown in this embodiment, a pair of spaced apart openings 26′ can be provided. These openings 26′ can function as an inlet and outlet respectively for flow of heat exchange fluid through the compartment 25′. Thus, for example, during the fermentation process, a fluid can flow through an inlet opening 26′ to circulate within the compartment 25′ about container 7 before exiting through the outlet opening 26′. That fluid may be either a liquid or gas, and may be heated or cooled so as to control the temperature of the must M in the container 7 during the fermentation process.

In a variation of the embodiment described with reference to FIG. 6, the function of the holding container 7 and the control container 22′ are reversed. That is, the control container 22′ becomes the holding container 7 holding a quantity of must M in the control compartment 25, whilst the holding container 7 acts as the control container 22′ to force the juice J from the control compartment 25 out through opening 26′. With this variation, pressure fluid is introduced by hose H into the holding compartment 8 through opening 12 causing the holding container 7 to inflate and apply a force to the must M in the control compartment 25. That force causes the juice J to flow out through opening 26′. The juice J can be removed through hose H′.

A further embodiment of the apparatus is shown in FIG. 7 of the drawings. That drawing again shows the apparatus 1 in the same stage of use as shown in FIGS. 3 and 6 of the previous embodiments.

In this embodiment, apparatus 1 incorporates an inner bag like holding container 7″ and an outer bag like control container 22″ manufactured together in a pillow-like construction. Thus, the holding container 7″ and control container 22″ are each fabricated from flat pieces of sheet material welded or otherwise seated together along their edges to form seam 28″ extending continuously about the edges of the sheet material pieces. With this arrangement, an upper sheet material piece forms the top wall 9″ and the upper part of the side walls 11″ of the holding container 7″ whilst a lower sheet material piece forms the bottom wall 10″ and the lower part of the side walls 11″ of that container 7″. At least the upper sheet material pieces forming the containers 7″ and 22″ are composed of stretchable material. As with the previous embodiments, this construction allows the upper part of the containers 7″ and 22″ to distend into a dome shape under internal pressure generated during the fermentation process.

The control container 22A defines control compartment 25″ in which holding container 7″ is positioned. Coupling 13 in the top wall 9″ of the container 7″ also extends through the top wall of container 22″ to provide access opening 12 for flow of grapes or must M and juice J or wine therethrough. Container 22″ may be seam welded or otherwise sealed to the coupling 13 to maintain the integrity of the compartment 5″.

An opening 26″ is provided in the container 22″ adjacent the bottom thereof for supplying low pressure fluid into the compartment 25″. That pressure acts to raise the lower sheet material piece forming the bottom wall 10″ and lower part of the side walls 11″ of the holding container 7″. As a result, juice or wine is cause to be removed from the compartment 8 as in previous embodiments. Opening 26″ is defined by a pipe or hose coupling 27″ for connection of a pipe or hose (not shown) supplying the low pressure fluid into the compartment 25″.

Although not shown, additional openings 26″ can be provided into compartment 25″ for flow of heat exchange fluid through that compartment

The composition of the sheet material forming the holding and control containers will vary depending on the purpose of the apparatus 1. In the exemplary application of the apparatus, the sheet material composition can vary for fermentation of red and white wines as well as for pro- and post-maceration. Variation of the sheet material properties, such as carbon dioxide and oxygen permeability characteristics can lead to significant improvements in wine quality including wine colour, aroma and astringency.

Examples of suitable sheet materials for containers of apparatus embodiments shown in FIGS. 6 and 7 of the drawings, when used for grape fermentation and maturation, are as follows:

Red Wine Fermentation

A control container comprising two layers of 150 micron ultrastrong blended polyethylene.

A holding container comprising a single layer of 80 micron food contact polyethylene.

White Wine Fermentation

A control container comprising a single layer of 112 micron metallised polyester.

A holding container comprising two layers of 100 micron food contact polyethylene.

The metallised polyester layer minimises transmission of carbon dioxide and oxygen between the must M and external environment, whilst the polyethylene layers provide excellent integrity and overall container strength.

Wine Maturation

The containers can be made in different materials to provide different levels of oxygen permeability. Control and holding containers each comprising a single layer of 100 micron linear polyethylene would allow approximately 1000 cc/M²/24 hours (100% oxygen) at 25° C. Such a container construction could be used for rapid maturation.

Holding containers made from various thicknesses of polyethylene sheet material, and control containers made of nylon co-extrusion would allow varying levels of carbon dioxide and oxygen to permeate to the holding compartment, creating opportunities for medium and slow maturation of between approximately 80 and 250 cc/M²/24 hours (100% oxygen) at 25° C.

It will be appreciated from the foregoing description that the apparatus. container and method are relatively simple and inexpensive They are particularly suitable for handling crushed fruit and must, and other flowable materials, where the volume of material to be handled is difficult to predict and has seasonal fluctuations. In that regard, the apparatus and container provide considerable capital cost savings compared with existing handling apparatus. In particular, the apparatus does not require expensive special purpose equipment to assist in handling the crushed fruit or must. Moreover, additional machinery for separating the fruit juice or wine and skins, and for pressing the ferment to extract the resultant wine can be avoided.

Preliminary trials in fermenting wine grapes using the apparatus and method indicate a significant increase in the levels of phenolics leading to better wine colour stability. In addition, varietal aromas are enhanced, as is the level of wine astringency, leading to a more balanced and stable wine. In addition, pre-fermentation maceration of the grape must using the apparatus and method has revealed good colour extraction from Shiraz grapes, with subsequent post-fermentation maceration softening the wine.

The apparatus and method of the present invention requires minimal cleanup following use. The single use, removable container means that it can be discarded following use, and the crushed fruit or must residue can be similarly discarded or simply removed for separate processing.

Finally, it is to be understood that various alterations, modifications and/or additions may be made to the apparatus and method without departing from the ambit of the present invention as defined in the claims appended hereto.

1. A container apparatus for handling fruit must, including: a rigid support structure; and, a flexible container for holding a quantity of fruit must, the holding container being supported by the support structure when holding the must, and the holding container having at least one opening through which at least juice of the must, or wine, is removed therefrom

2. A container apparatus as claimed in claim 1, and further including control means for applying a force to the must causing the must juice or wine to flow out through the or at least one opening in the holding container.

3. A container apparatus as claimed in claim 2, wherein the control means is operable to apply a force to the must causing the must to be pressed and juice to be separated from fruit pulp and skins of the must.

4. A container apparatus as claimed in claim 2 or 3, wherein the control means includes a control member inflatable to press against the must.

5. A container apparatus as claimed in claim 4, wherein the control member includes an inflatable control container having a control compartment expandable under pressure of fluid introduced into the control compartment so as to inflate the control container.

6. A container apparatus as claimed in claim 5, wherein the control container is located between the holding container and the rigid support structure, the rigid support structure restraining the control container and controlling the direction of inflation of the control container toward the holding container so as to apply a force to the holding container and thereby apply the force to the must.

7. A container apparatus as claimed in claim 6. wherein the control container is located beneath the holding container, inflation of the control container causing the bottom of the holding container to progressively rise so as to press the must juice between the rising container bottom and a top of the holding container.

8. A container apparatus as claimed in claim 6, wherein the control container at least partially surrounds the holding container, inflation of the control container causing the holding container to deflate and apply a force to the must.

9. A container apparatus as claimed in claim 8, wherein the control container extends over the top and about the side(s) of the holding container.

10. A container apparatus as claimed in claim 5, wherein the holding container is located between the control container and the rigid support structure, the rigid support structure restraining the holding container as the control container inflates so as to apply a force to the must.

11. A container apparatus as claimed in claim 10, wherein the holding container at least partially surrounds the control container, inflation of the control container causing the must to progressively compress outwardly against the rigid support structure.

12. A container apparatus as claimed in claim 11, wherein the control container is located within the holding container.

13. A container apparatus as claimed in any preceding claim, wherein the holding container is a holding bag.

14. A container apparatus as claimed in any one of claims 5 to 13, wherein the control container is a press bag.

15. A container apparatus as claimed in claim 14 when appended to claim 13, wherein the press bag is formed integral with the holding bag.

16. A container apparatus as claimed in any preceding claim, wherein the holding container is comprised of gas permeable sheet material to permit micro oxygenation of the must.

17. A container apparatus as claimed in any preceding claim, wherein the holding container is composed of gas permeable sheet material to permit escape of ferment gas from the holding container

18. A container apparatus as claimed in any preceding claim, wherein the at least one opening is at or adjacent the top of the holding container.

19. A container apparatus as claimed in any preceding claim, and further including means for controlling the temperature of the fruit must in the holding container.

20. A container apparatus as claimed in claim 19, wherein the temperature control means includes a passageway adjacent the holding container, passage of heat exchange fluid through the passageway causing convected transfer of heat between the heat exchange fluid and the must in the holding container,

21. A container apparatus as claimed in claim 20 when appended to claim 5 or any claim appended thereto, wherein the passageway is provided by the control compartment, and the control container has at least two openings into the control compartment to enable flow of heat exchange fluid into and out of the openings, respectively.

22. A container apparatus as claimed in any preceding claim, wherein the rigid support structure includes a support base and at least one support wall upstanding from the base and together defining a storage space in which the holding container is located.

23. A container apparatus as claimed in claim 22, wherein the rigid support structure includes a support crate having a pallet support base and 4 support walls upstanding therefrom.

24. A container apparatus for handling fruit must, including a holding container composed of flexible sheet material for holding a quantity of fruit must, the holding container having at least one opening for removing at least juice of the must or wine, therefrom.

25. A flexible bag container for handling fruit must, the container including:
a holding compartment for holding a quantity of fruit must; at least one opening from the holding compartment through which must is removed therefrom: a control compartment adjacent the holding compartment; and, at least one opening into the control compartment for introducing a pressing fluid so as to expand the control compartment and apply a force to the adjacent holding compartment causing at least juice of the must, or wine, to flow out through the or at least one opening from the holding compartment.

26. A flexible bag container for handling fruit must, the container including:
a holding compartment for holding a quantity of fruit must: at least one opening from the holding compartment through which must is removed therefrom; a control compartment adjacent the holding compartment: and, at least one opening into the control compartment for introducing a heat exchange fluid so as to cause convected transfer of heat between the heat exchange fluid and the must in the holding compartment

27. A flexible bag container as claimed in claim 25 or 26, wherein the control compartment is located beneath the holding compartment.

28. A flexible bag container as claimed in claim 25 or 26, wherein the holding compartment is located within the control compartment.

29. A flexible bag container as claimed in claim 25 or 26, wherein the control compartment is located within the holding compartment.

30. A flexible bag container as claimed in claim 28 of 29, and further including an outer bag, and an inner bag within the outer bag, one of the compartments being provided within the inner bag and the other compartment being provided externally of the inner bag and within the outer bag,

31. A flexible bag container as claimed in any one of claims 25 to 30, wherein the at least one opening from the holding compartment is located in a top wall of the bag container.

32. A container apparatus as claimed in any one of claims 25 to 31, wherein the at least one opening into the control compartment is located in a side wall adjacent a bottom wall of the bag container.

33. A flexible bag container as claimed in any one of claims 25 to 31, wherein the at least one opening into the control compartment is located in a top wall of the bag container.

34. A flexible bag container as claimed in any one of claims 25 to 32, and further including at least one holding compartment wall defining the holding compartment, the holding compartment wall being composed of gas permeable sheet material to permit micro oxygenation of the must, or must juice or wine in the holding compartment.

35. A flexible bag container as, claimed in any one of claims 25 to 32, and further including at least one holding compartment wall defining the holding compartment, the holding compartment wall being composed of gas permeable sheet material to permit escape of ferment gas from the holding compartment.

36. A flexible bag container for grape must fermentation, the container including: an inner bag for holding a quantity of grape must during fermentation; at least one opening from the inner bag through which ferment is removed therefrom; an outer bag containing the inner bag, the inner and outer bags being composed of sheet material having predetermined gas permeability characteristics for controlling gas flow between the grape must and the container exterior.

37. A method for handling fruit must, including: positioning a flexible holding container in a rigid support structure; pouring a quantity of fruit must into the holding container, the holding container being supported by the support structure; and, removing at least juice of the must, or wine, through an opening from the holding container.

38. A method as claimed in claim 37, and further including fermenting the must in the holding container, so that wine is removed through the opening from the holding container.

39. A method as claimed in claim 37 or 38, and further including applying a force to the must causing the must to be pressed and juice to be separated from fruit pulp and skins of the must.

40. A method as claimed in claim 39, wherein pressing the must forces the must juice or wine through the opening from the holding container.

41. A method as claimed in claim 39 or 40, wherein applying a force to the holding container includes introducing fluid under pressure into a control compartment of a control container causing the control compartment to expand so that the control container presses against the holding container.

42. A method as claimed in claim 41, wherein the control container inflates upwardly against the bottom of the holding container causing the bottom of the holding container to rise and press the must between the rising holding container bottom and a top of the holding container.

43. A method as claimed in claim 40, wherein the control container at least partially surrounds the holding container, and the fluid introduced into the control compartment causes the holding bag container to progressively deflate so as to press the must.

44. A method as claimed in claim 41, wherein the control container is at least partially surrounded by the holding container and the fluid introduced into the control compartment causes the control container to inflate and apply a force to the must.

45. A method as claimed in any one of claims 37 to 44, and further including permeating oxygenating gas through walls of the holding container to micro oxygenate the must in the holding container.

46. A method as claimed in any one of claims 37 to 44, and further including permeating ferment gas through walls of the holding container from the must out of the holding container.

47. A method as claimed in any one of claims 38 to 46, and further including inserting a fermentation tube through the opening from the holding container into the must, fermenting juice and ferment gas flowing along the fermentation tube and exiting from an upper open end thereof, the ferment gas being removed and the fermenting juice returning to the holding container.

48. A container apparatus for handling fruit must, substantially as hereinbefore described in any one of the embodiments with reference to what is shown in the accompanying drawings.

49. A flexible bag container for fruit must, substantially as hereinbefore described in any one of the embodiments with reference to what is shown in the accompanying drawings.

50. A method for handling fruit must, substantially as hereinbefore described in any one of the embodiments with reference to what is shown in the accompanying drawings.
